(19) United States
(12) Patent Application Publication
(10) Pub. No.: US 2014/0210578 A1
(43) Pub. Date: Jul. 31, 2014

(54) SOLID ELASTIC SPHERE LEVITATION DEVICE

(71) Applicant: MICHAEL C. HUNDELT, Clayton, MO (US)

(72) Inventor: MICHAEL C. HUNDELT, Clayton, MO (US)

(21) Appl. No.: 14/169,397

(22) Filed: Jan. 31, 2014

Related U.S. Application Data
(60) Provisional application No. 61/849,633, filed on Jan. 31, 2013.

(51) Int. Cl. H01F 7/20; H01F 7/02

(52) U.S. Cl. CPC H01F 7/206; H01F 7/0273
USPC 335/291

(57) ABSTRACT

This device temporarily suspends a solid elastic sphere over a specific location. The sphere is composed of evenly dispersed high performance anisotropic powder bonded to an elastic polymer. Levitation of the sphere occurs with an optimized levitation by means of permanent magnets. The equilibrium is stable along one or two axis by means of these permanent magnets, and along one or two others by means of a combination of electromagnets of near zero consumption at equilibrium.

### CROSS-REFERENCE TO RELATED APPLICATION

This non-provisional application claims priority to the pending provisional application 61/849633 filed on Jan. 31, 2013 which is owned by the same inventor.

### BACKGROUND OF THE INVENTION

The solid elastic sphere levitation device generally relates to sporting goods and more specifically to a device that levitates an elastic sphere above a specific location.

One application is the game of golf, the axially polarized magnetic elastic core inside a golf ball allows the golfer to suspend the ball to optimal heights for specific equipment and swing styles.

Subsequent benefits of utilizing a magnetic object versus a non-magnetic object is the ability to control the rotation rate of the sphere prior to contact, and the propensity of tracking magnetic anomalies in a non-magnetic environment. Valuable data processing opportunities in golf include; ball-location, ball-flight, score, handicap, pace of play, rule violations, and the like.

The invention is applicable to simulated golf. The magnetic golf ball is suspended using an electronically controlled magnetic tee placed under a hitting surface, which allows a golf simulator software to dictate the golf ball's spatial orientation.

The state of the art for levitation devices comprises a solid non-spherical and non-elastic sintered NdFeB magnet that acts as a platform for a non-magnetic object to appear to be levitating over a base that comprises sources for the magnetic field. These devices are applicable to items of decoration, advertising communication, or with industrial applications that require the levitation of an item.

The state of the art for temporarily suspending solid elastic spheres comprises items that physically touch the sphere at the base in order to keep the sphere stationary in a specific location.

### DESCRIPTION OF THE PRIOR ART

Over the years, various simulators and platforms have appeared for transportation, medical, and other non sport training. Select simulators have also developed and supported training of athletes at all skill levels in most sports. Many sports utilize an object propelled from a starting point to a target using equipment subject to rules. The usual object in a sport is some kind of ball. Golf is no different and has its ball subject to intense regulation by the USGA. A golf game begins with a shot from a tee box. A player places a ball on a tee and seeks a drive. Keeping the ball above the tee box makes for a better shot. Various elements of the prior art have sought to elevate balls and other things.

U.S. Pat. No. 4,585,282 provides for a levitation of an item from underneath means of a permanent magnet set, but the set does not aim to stabilize the item versus turn over. In this patent, the pyramid, for proper support as a levitated element, must be stabilized against movement in a number of modes, the principal-ones are defined as follows: mode 1 refers to vertical or axial motion, up or down from the null position; mode 2 is principally translational motion from side to side relative to the side position, although it includes an element of pivoting of the pyramid as the pyramid deviates transversely from the null position; mode 3 is principally a tilting mode from some center of pivoting within the pyramid. Each of these modes involves oscillation relative to the null position, which oscillation is damped under the influence control circuitry. Modes 1, 2 and 3 can have, for example, the resonant frequencies 1.5, 1 and 5 Hz respectively.

The '282 patent considers the possibility of a vertical stability and a horizontal instability, excluding the possibility of others. In this situation, an oscillating mode 2 is only produced when a servo-control is active. The Ernshaw theorem, how ever, makes these oscillations impossible in mode 2 when only permanent magnets are engaged. Thus the aim and result of this set of permanent magnets does not separate the translational stability from the turnover stability. As a result, without corrective coils, the levitating item turns up side down, falls rapidly on the base and gets stuck on it.

The above-mentioned modes 2 and 3 exist in the two perpendicular directions of the horizontal plane. Thus, this situation requires at least 4 independent corrective coils.

The '282 patent also mentions movement modes defined as non-principal modes. These modes would require supplementary coils in order to stabilize the corresponding movements. The system implies no more than 5 independent modes whatever the magnetic situation is, three translations and two rotations (turnover), since the vertical axis corresponds to a free rotation. As provided above, mode 2 and 3 are double. Thus said, non-principal modes must be a combination of the 1, 2 and 3 modes, and this shows that the movement of the levitating item is not understood.

Second, the corrective coils of the '282 patent are not independent: each pair is given only one current thus a total of two currents. As a result, it is then impossible mathematically to control a four dimensional instability. Moreover, these coils are located essentially in order to get the turnover stability and only correct extremely weak shifts from the translational equilibrium point. So these coils correct the translational shift in normal every day situations. This system would require a user to locate an exact translational equilibrium point, and no solution is given for that.

Third, these coils are in place where they cannot accept iron cores wherein said iron cores would trap the magnetic field on the top of the base crown and lead it sideways from where it goes directly to the bottom side of the base crown, thus without touching the golf ball that then wouldn't levitate any more. Without iron cores, the currents of the coils have to be very high to the point that they exclude a permanent use. Since the permittivity of iron can reach a value of 1000 easily, due to the absence of the iron, the force provided by a coil in this configuration is reduced by a factor 1000, and consequently this does not allow any compensation of the magnetic instability.

The strength of the coil with no iron component and with a current large enough so that the coil heat 50° C. more that ambient temperature can only compensate an upper magnet drift of a mere 10 micron away from the center in one horizontal direction. This means it becomes impossible to stabilize the levitating device against any environment perturbation and drifts. The description is not sufficient to reach the goal of the present invention. In consequence, no application of the technology provided in the present invention has ever been demonstrated.

The '282 patent further uses oscillating circuits for the measurement of the levitating item displacements, but does not apply it to the detection of the exact equilibrium points. This requirement is essential for minimizing the power consumption, because this equilibrium point is not permanent. This point moves with the temperature, because magnets are not stable with the temperature, with the influence of magnetic sources around, with the influence of iron around, and with the fact that the levitating device can be put on a non-horizontal surface.

The U.S. Pat. No. 5,168,183 describes a device, which claims lift above a source of magnetic field, different than the current invention. The difference between the present invention and the '183 patent is better understood in the light of the physical constraints of the magnetic levitation.

A theorem attributed to Ernshaw proves it impossible to obtain a static levitation by using a combination of fixed magnets. The static levitation implies a stable suspension of one item against gravity.

Magnetostatic and gravitational energies Em, Eg and total E of any system are given by:

Em=fym.B dv.Eg=f pP dv, E=Em+Eg=fym.B+pP dv

Where m and p are the density of magnetic moment and of mass of the levitating item, B and P are the local magnetic fields and gravitational potential. We call X, Y and Z the coordinates of the center of gravity of the item to be put in levitation. Equilibrium in a direction X takes place when the first derivative of E according to X from is zero, and this equilibrium is stable or unstable with respect to small displacements according to whether the second derivative of E is according to X is positive or negative, that is whether:

∂²E/∂X²>0, or ∂²E/∂X²<0

and the same according to Y and Z. However (1)

∂²E/∂X²+∂²E/∂Y²+∂²E/∂Z²=∫y(m(∂²/∂X²+∂²/∂Y²+∂²/∂Z¹)

B+p(∂²/∂X²+∂²/∂Y²+∂²/∂Z²)P)dv=0

since in steady state the laplacians of B and Pare zero outside of the matter, which is their source.

The sum of these three stability criteria is thus necessarily zero: whatever is the choice of three axes perpendicular between them, the item is always unstable in one or two directions at most, and the more it is stable in a direction the more it is unstable in the two others.

This theorem applies even to the flexible and paramagnetic items (but not to the diamagnetic ones). They will be always unstable with respect to translation motions of the whole item for any equilibrium position.

Returning to the '183 patent, it describes several implementations of levitation devices that circumvent the limits of the Ernshaw theorem by means of variable magnetic fields, which make it possible to control the position of the sustained item.

According to the presented principles, the golf ball, a magnetic object, is stable in a horizontal plane by fields delivered by several permanent magnets, but unstable on a vertical axis, and stabilized by an electromagnet controlled by a measure of location of the golf ball.

In both cases, the magnet is unstable in rotation. Indeed the sustained is magnet turns over spontaneously such that it gets stuck to the permanent magnets, and no solution is indicated to prevent this condition. It is explained how to prevent overturning by connection of 2 or more levitating magnets over 2 or more bases. This systems, however limits the lift efficiency, as in compactness, and completely exposed to the viewer. Additionally, these conventional systems do not account for the effect of gravity on the items, nor the consequence, which this gravity can have on the stability of the levitation. As it is, the expert seems to have to implement this levitation in weightlessness, which reduces considerably the capability of U.S. Pat. No. 5,168,183. It specifies well indeed that the device works independently of ambient gravity, and it is indeed very ineffective according to the described means if not in weightlessness. With NdFeB magnets it appears impossible that the best ferromagnetic alloys now available could carry just themselves in the bearing zone given by the magnet devices.

These deficiencies, however, are foreseeable for the conventional systems since unstable equilibrium along the axis X (perpendicular to in the plan of stability) stays at a distance from the magnets necessarily definitely larger than that of the bearing zone commonly used. Then, the field of gravity moves this equilibrium point even further from the magnets, however, the magnetic bearing decreases extremely rapidly with the distance to the magnets. Consequently, these conventional systems are intended for the applications in low or zero gravity.

Turning to a Stabilizing Device, the equation of a one-dimensional motion in the X direction of a mass m in a potential field E(X) with a dampening force D(JX/Jt) and a random force R(t) is given by:

m∂²X/∂t²=−∂E/∂X+D+R

In our case the random force is due to air streams and electronic noise, and the dampening force D is basically due to the air viscosity thus linear versus velocity:

D=AJJ(lat

This gives a stable equilibrium if J2E/JX2>0, or an unstable one if J 2E/JX2<0.

The state of art method consists in adding a corrective potential C(X) that brings the item back to its equilibrium point as soon as it leaves it as in

aC/aX=O, and

a2 C!aX2>−a2E/aX2, which we write with a simpler notation:

c>e.

Supposedly this uses no more power than the random force R requires. But practically C(X) cannot be exactly centered on X=O, but on X0,0. Then the equilibrium point is not at X=O but at X=(c/(c+e)) X0; providing a real disadvantage in that a force (c2/(c-+e)) X created by the corrective system, and this is energy consuming. For instance levitating 100 g requires easily several watts for stabilizing the equilibrium along each dimension needing it.

The present invention overcomes the disadvantages of the prior art and provides a flange tightening tool that utilizes a pair of pins upon a tool that engages apertures upon a flange so that the tool rotates the flange readily without slippage or falling off.

### SUMMARY OF THE INVENTION

Generally, the solid elastic sphere levitation device has a single dipole magnetic object polarized axially. The device has an optimized levitator by means of permanent magnets. The equilibrium is stable along one or two axes by means of these permanent magnets, and along one or two other axes by means of a combination of electromagnets of near zero power consumption at equilibrium. The solid elastic sphere of the device can be heavy and the levitation process is also completely quiet. The surface above or below which the item levitates, is flat or at least regular. The space between the surface and the item is free and empty of any other mechanism or debris. The arrangement implemented for the levitation is discreet. The levitating solid elastic sphere is also stable with limited instances of turnover or inversion. The levitating solid elastic sphere rotates in a controlled manner around the vertical or tilted axis, free or maintained. The levitation consumes little energy, or is permanent or at least autonomous of a power supply over long time duration.

There has thus been outlined, rather broadly, the more important features of the invention in order that the detailed description thereof that follows may be better understood and that the present contribution to the art may be better appreciated. The present invention also includes a magnetic ball of four Layers: neodymium iron boron, a rubber composite, another rubber composite, and a thermoplastic resin; and, the magnetic sphere core is a single dipole magnetic object polarized axially. Additional features of the invention will be described hereinafter and which will form the subject matter of the claims attached.

Numerous objects, features and advantages of the present invention will be readily apparent to those of ordinary skill in the art upon a reading of the following detailed description of the presently preferred, but nonetheless illustrative, embodiment of the present invention when taken in conjunction with the accompanying drawings. Before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, the phraseology and terminology employed herein are for the purpose of description and should not be regarded as limiting.

One object of the present invention is to provide a solid elastic sphere levitation device that suspends a ball above a selected point.

Another object is to provide such a solid elastic sphere levitation device that provides computer controlled precision ball positioning.

Another object is to provide such a solid elastic sphere levitation device m that provides frictionless ball striking.

Another object is to provide such a solid elastic sphere levitation device that minimizes fatigue in a user who operates the invention repetitively.

Another object is to provide such a solid elastic sphere levitation device that can be manufactured and sold at a price suitable for purchase the players of various levels of means.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In referring to the drawings,

FIG. 1 is a top view of the invention;

FIG. 1a is a partial sectional view of the invention;

FIG. 2 is a circuit diagram of the proportional-derivative control of the invention;

FIG. 3 is a top view (a) and a bottom view (b) of the printed circuit board, proportional-derivative control of the invention;

FIG. 4 is a top view (a) and a bottom view (b) of the printed circuit board including six electromagnetic field coils, a top view (c) of the coil layout, a top view (d) of one coil, and a side view (e) of one coil of the invention;

FIG. 5 is a top view (a) and a bottom view (b) of the printed circuit board including three hall-effect sensor array of the invention; and,

FIG. 6 is a sectional view of an exemplary solid elastic sphere golf ball.

The same reference numerals refer to the same parts throughout the various figures.

### DESCRIPTION OF THE PREFERRED EMBODIMENT

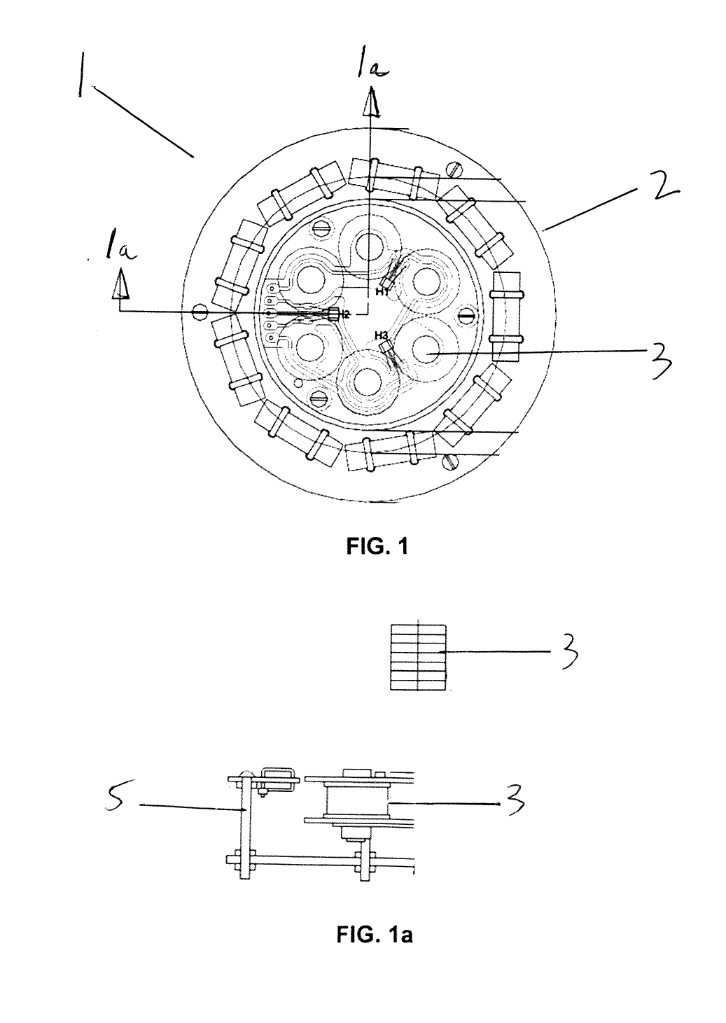

The present art overcomes the prior art limitations by providing a solid elastic sphere levitation device. The device 1 begins as shown in FIG. 1 with a permanent magnet enclosure 2 is designed to safely hold the permanent magnets 3 as a magnetic golf ball is struck above them. The permanent magnets pull down the magnetic ball as the electromagnets apply a repulsive force upwards.

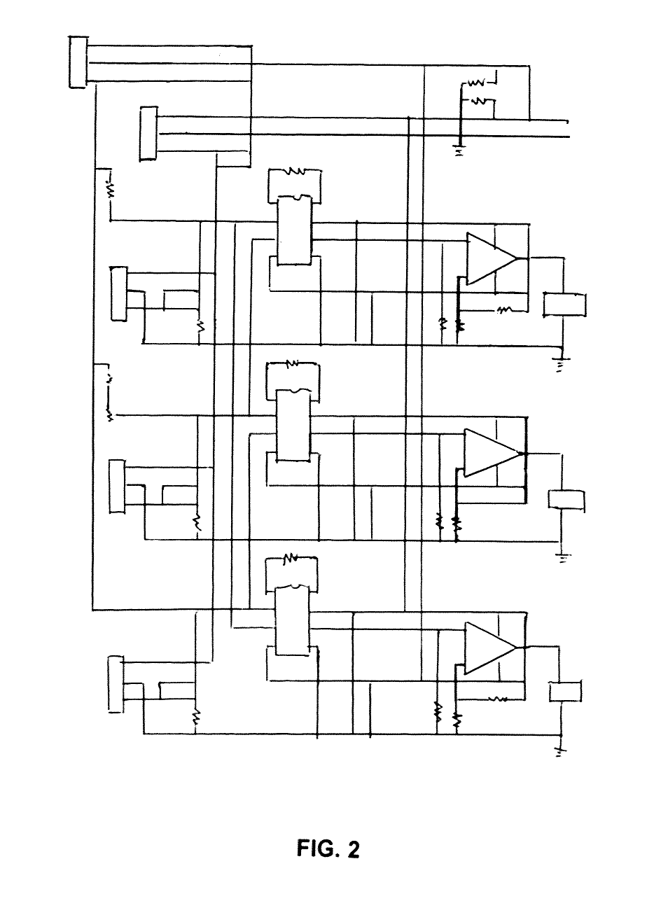

FIG. 1a shows a partial sectional view along two section lines generally orthogonal from a common center. Each electromagnet 3 has a construction of stacked layers. Each electromagnet then fits within a mounting plate 5 as shown. is FIG. 2 then provides a circuit diagram of a proportional derivative control 6 of the invention. This control applies the electromagnetic force to a magnetic ball to establish a stable suspension of it.

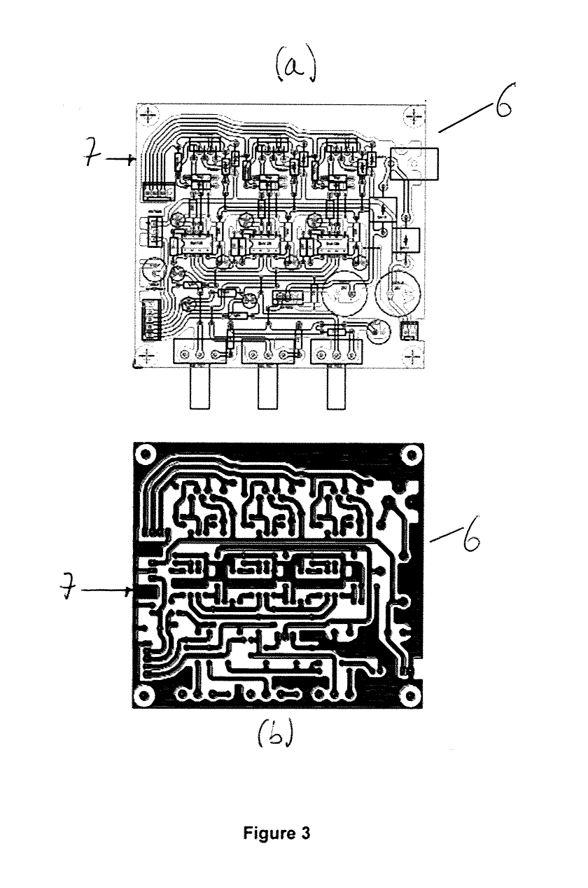

FIG. 3 describes a top view (a) of a circuit board 7 for the proportional derivative control 6. Then the control 6 has a bottom view (b) show of its circuit board.

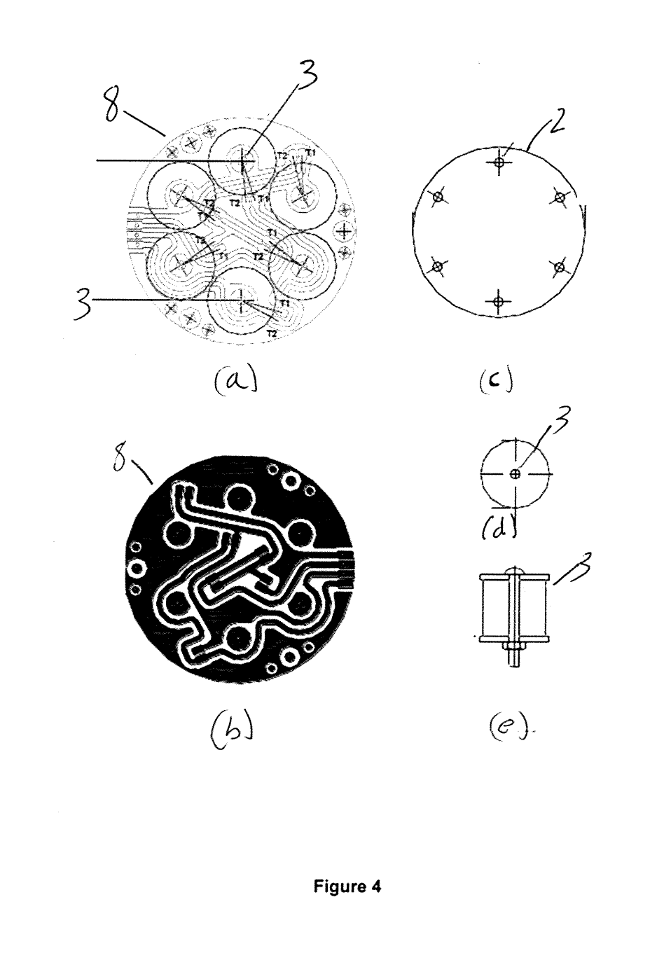

FIG. 4 provides a top view (a) of a printed circuit board 8 for a six electromagnet 3 field. The printed circuit board has a bottom view as in (b). Within the permanent magnet enclosure, the magnets have an equiangular positioning show in the top view (c). One electromagnet appears in its top view as in (d) and in its side view (e).

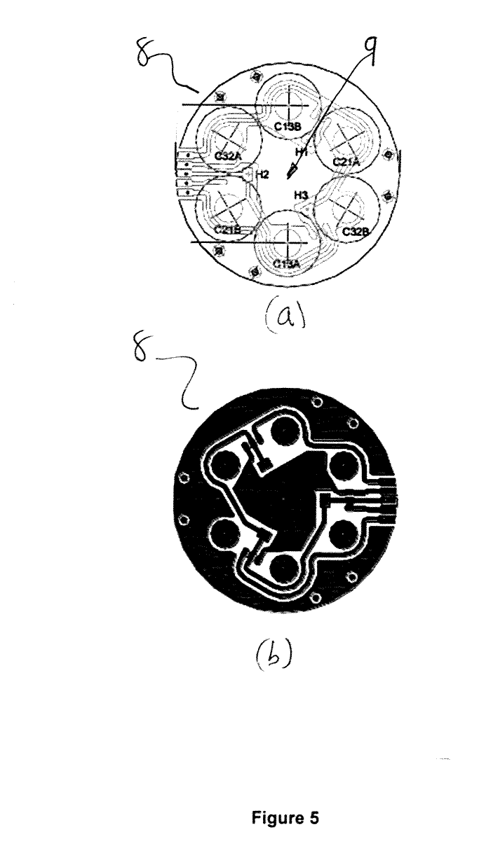

FIG. 5 then illustrates a three Hall-Effect sensor array in a top view (a) of the circuit board 8. The sensors are positioned in a triangular fashion around the center of the levitation platform, as at 9. The Hall-Effect sensors pick up the distance between the sensor and the object being levitated, that is ball 4, and relay that information to proportional derivative control. This information allows for heavier objects to be compensated with additional electromagnetic repulsive force. This array appears in a bottom view (b).

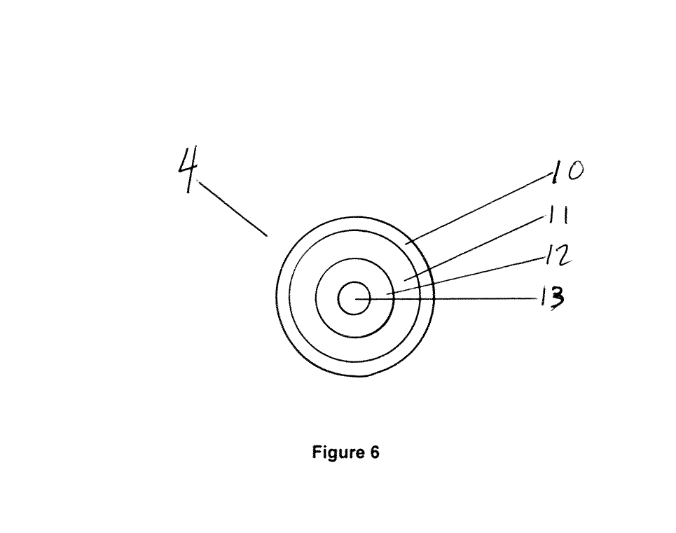

And, FIG. 6 shows a golf ball 4 in a sectional view. The golf ball these layers described from the surface inwardly. A surface cover 10 of thermoplastic resin such as surlyn, a first rubber composite layer 11, a second rubber composite layer 12, and a neodymium iron boron magnetic core 13.

From the aforementioned description, a solid elastic sphere levitation device has been described. The solid elastic sphere levitation device is uniquely capable of levitating a golf ball for repetitive hitting by a player in a simulator. The solid elastic sphere levitation device and its various components may be may be manufactured from many materials, including but not limited to, steel, aluminum, neodymium, polymers, ferrous and non-ferrous metal foils, their alloys, and composites.

Various aspects of the illustrative embodiments have been described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations have been set forth in order to provide a thorough understanding of the illustrative embodiments. However, it will be apparent to one skilled in the art that the present invention may be practiced without the specific details. In other instances, well known features are omitted or simplified in order not to obscure the illustrative embodiments.

Various operations have been described as multiple discrete operations, in a manner that is most helpful in understanding the present invention, however, the order of description should not be construed as to imply that these operations are necessarily order dependent. In particular, these operations need not be performed in the order of presentation. Moreover, in the specification and the following claims, the terms “first,” “second,” “third” and the like—when they appear—are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to ascertain the nature of the technical disclosure. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

As such, those skilled in the art will appreciate that the conception, upon which this disclosure is based, may readily be utilized as a basis for the designing of other structures, methods and systems for carrying out the several purposes of the present invention. Therefore, the claims include such equivalent constructions insofar as they do not depart from the spirit and the scope of the present invention.

1. A solid elastic sphere that magnetically levitates, comprising: a base; and a solid elastic sphere made with magnetic material wherein the sphere levitates by interacting with the base in a stable arrangement without turning over, wherein the sphere is positioned above or below the base, and the base is configured to be either under or above the activity surface that are separated by a distance.

2. The device according to claim 1, wherein the base is electrically operated.

3. The device according to claim 1, wherein the base is supplied electricity by a lower power converter.

4. The device according to claim 1, wherein the solid elastic sphere turns on one of a vertical and a tilted axis.

5. The device according to claim 1, wherein the base comprises: at least one permanent lifting magnet distributed in a crown having an approximately cylindrical symmetry.

6. The device according to claim 1, further comprising: one solid elastic sphere, wherein the sphere has a field with a cylindrical symmetry at least when the base does not have a cylindrical symmetry.

7. The device according to claim 6, wherein the magnets of the base are directed such that a magnetic field produced by the magnets pushes against an arrangement of magnets in the base an amount exactly equal to a weight of the solid elastic sphere at a specific height.

8. The device according to claim 6, wherein the electromagnetic field oscillation algorithm processes speed sensor data to manage the field coils and thus the sphere's horizontal rotation.

9. The device according to claim 6, wherein the magnets of the item are unstable in translation along at least one axis but stabilized by a control device, wherein the control device has a number of sensors as a number of axes of instability, wherein the sensors measure a displacement of a center of gravity of the rubberlike object along the axes of instability relative to the base and the control device has at least as many independent processing circuits as a number of axes of instability, driven from signals from the sensors that control current to the magnets configured as electromagnets and at least as many independent windings as the number of axes of instability forming the electromagnets that generate the magnetic fields, wherein the magnetic fields generated correct for displacements of the solid elastic sphere made to bring the item back to an equilibrium point by acting on the magnetic properties of the item.

10. The device according to claim 1, wherein the solid elastic sphere is not one of free rotation and maintained in motionless levitation around a vertical axis due to the electromagnetic field oscillation.

11. The device according to claim 10, wherein the solid elastic sphere has a cylindrical dissymmetry such that the base magnets set the sphere in rotation.

12. The device according to claim 9, wherein the sensor delivers a signal essentially proportional to a variation of a position of the item compared to an axis of the base, wherein the sensor is one of a magnetic sensor for a probe measuring the Hall Effect, a strain gauge sensor, a polymer with a variable resistor.

13. The device according to claim 9, wherein the sensor delivers a signal essentially proportional to a derivative versus time of a position of the item.

14. The device according to claim 12, wherein each processing circuit comprises an amplifier, a filter and tran-sistors of power.

15. The device according to claim 14, wherein the control device comprises a damping of oscillation by an arrangement of a derivative filter device.

16. The device according to claim 14, wherein the control device comprises diodes configured to produce the non-equilibrium of the item in the horizontal plane.

17. The device according to claim 16, wherein the base is configured with adjustments to compensate for permanent non-equilibrium.

18. The device according to claim 16, wherein the electronic is configured with automatic compensation for per-manent non-equilibrium in order to suppress average con-sumption of the coils.

19. The device according to claim 13, wherein a corrective forced produced by the electromagnets is a sum of two items, wherein a first is proportional to an acceleration of the levitating solid elastic sphere and has at least an intensity necessary to produce an inversion of stability and a second is proportional to a dampening of the solid elastic sphere and has an opposite direction, and has an intensity necessary to get a dampened inversion of stability.
